(19) United States
(12) Patent Application Publication
(10) Pub. No.: US 2025/0219128 A1
(43) Pub. Date: Jul. 3, 2025

(54) LITHIUM ION SECONDARY BATTERY

(71) Applicant: MAXELL, LTD., Otokuni-gun, Kyoto (JP)

(72) Inventors: Kentaro Tomita, Otokuni-gun (JP); Haruki Kamizori, Otokuni-gun (JP)

(73) Assignee: MAXELL, LTD., Otokuni-gun, Kyoto (JP)

(21) Appl. No.: 18/851,267

(22) PCT Filed: Mar. 8, 2023
(86) PCT No.: PCT/JP2023/008808

§ 371 Date: Sep. 26, 2024

(30) Foreign Application Priority Data
Mar. 31, 2022 (JP) 2022-059735

(51) Int. Cl. H01M 10/0525; H01M 4/02; H01M 4/36; H01M 4/485; H01M 4/58; H01M 10/0562

(52) U.S. Cl. CPC H01M 10/0525; H01M 4/364; H01M 4/485; H01M 4/5825; H01M 10/0562; H01M 2004/027; H01M 2300/0068

(57) ABSTRACT

The lithium-ion secondary battery can easily detect remaining capacity by a detection means using a voltage detection method. The lithium ion secondary battery of the present invention is related to Goals 3, 7, 11, and 12 of the SDGs. The lithium ion secondary battery of the present invention includes a solid electrolyte, and a first negative electrode active material which is a spinel type Li_{4-a-c}Ti_{5-b}M_{a+b}¹O_{12-δ}(M¹ is at least one element selected from the group consisting of Li, Na, K, Mg, Ca, Al Zn and transition metal elements, −1≤a≤0.5, 0≤b≤0.5, 0≤c≤0.5, −0.2≤δ≤1) and a specific second negative electrode active material. When the total amount of the first negative electrode active material and the second negative electrode active material contained in the negative electrode is 100% by volume, the proportion of the second negative electrode active material is 5% by volume or more. This is a characteristic feature.

### TECHNICAL FIELD

The present invention relates to a lithium ion secondary battery that is easy to detect the remaining capacity by a detection means using a voltage detection method.

### TECHNICAL BACKGROUND

The lithium ion secondary batteries are used for a portable electronic device such as portable telephones and notebook-sized personal computers, and a power supply of electric vehicles. Providing lithium ion secondary batteries to the society can contribute the achievement of Goal 3 (Ensure healthy lives and promote well-being for all at all ages), Goal 7 (Ensure access to affordable, reliable, sustainable and modern energy for all). Goal 11 (Make cities and human settlements inclusive, safe, resilient and sustainable) and Goal 12 (Ensure sustainable consumption and production patterns), among the seventeen lists of the sustainable developments goals (SDGs) established by the United Nations.

A lithium-containing composite oxide such as LiCoO₂ is generally used as an active material of the positive electrode of the lithium ion secondary batteries, and a carbon material such as graphite is usually used as an active material of the negative electrode. In addition, in order to construct a battery that can be charged and discharged at a large current value without causing an internal short circuit due to lithium deposition, a lithium titanium oxide such as Li₄Ti₅O₁₂ is also used as a negative electrode active material (see Patent Documents Nos. 1 to 6, etc.).

By the way, many of the devices in which lithium ion secondary batteries are applied are provided with means for detecting the remaining capacity so that the remaining capacity can be grasped during use. As a means for detecting the remaining capacity of a lithium ion secondary battery, it is common to detect the remaining capacity by any of the following detection methods: a voltage measurement method, a coulomb counter method, a battery cell modeling method, and an impedance track method. However, a fuel gauge IC is required for detection means using a detection method other than the voltage measurement method. Therefore, in devices that have a certain limit on the cost of detection means, such as a watch that uses a lithium ion secondary battery as a drive power source or a device that uses a lithium ion secondary battery as a backup power supply, it is preferable to employ a detection means using a voltage measurement method that is easier to reduce a low price.

However, lithium ion secondary batteries that use LiCoO₂ as the positive electrode active material and Li₄Ti₅O₁₂ as the negative electrode active material are used relatively frequently because they have excellent output characteristics and durability. However, at the stage where the remaining capacity is relatively small, the amount of change in voltage is too small, and at the end of discharge when the remaining capacity is very low, the voltage drops sharply. Therefore, it has been difficult to accurately detect the remaining capacity with the detection means using the voltage measurement method.

On the other hand, by using other negative electrode active material together with lithium titanium oxide, an attempt has been made to suppress a sudden voltage drop phenomenon at the end of battery discharge (see Patent Documents Nos. 7 and 8).

### Related Art References

### Patent References

Patent Reference No. 1: Japanese Laid-Open Patent Publication No. 2009-129644
Patent Reference No. 2: Japanese Laid-Open Patent Publication No. 2016-81691
Patent Reference No. 3: Japanese Laid-Open Patent Publication No. 2021-34326
Patent Reference No. 4: Japanese Laid-Open Patent Publication No. 2021-34328
Patent Reference No. 5: Japanese Laid-Open Patent Publication No. 2021-39860
Patent Reference No. 6: International Patent Publication No. 2021-44883
Patent Reference No. 7: Japanese Laid-Open Patent Publication No. H7-302587
Patent Reference No. 8: Japanese Laid-Open Patent Publication No. 2016-81691

### SUMMARY OF THE INVENTION

### The Objectives to Solve by the Invention

As described in Patent Documents 7 and 8, in batteries with non-aqueous electrolyte, the use of other negative electrode active materials together with lithium titanium oxide has a certain effect in suppressing the phenomenon of a sudden voltage drop at the end of the battery discharge. However, in batteries using negative electrodes containing solid electrolytes (e.g., all-solid-state batteries), it is difficult to accurately detect the remaining capacity of the battery, especially under conditions of different loads during discharge. This is considered because in batteries using negative electrodes containing solid electrolytes, it is difficult to improve the conductive path within the negative electrode because the solid electrolyte particles become an obstacle, and because other negative electrode active materials that have traditionally been used together with lithium titanium oxide are solid solution types, differences in the depth of charge in the thickness direction of the negative electrode are more likely to occur than in batteries with non-aqueous electrolytes.

For these reasons, in batteries that use lithimn titanium oxide as the negative electrode active material and a negative electrode that contains a solid electrolyte, there is a need to develop technology that enables accurate detection of remaining capacity using a detection means that utilizes a voltage measurement method using a means other than the conventional method.

The present invention has been made in view of the above circumstances, and has an object to provide a lithimn ion secondary battery in which the remaining capacity can be easily detected by a detection means that utilizes a voltage detection method.

### Means to Solve the Objectives

The lithium ion secondary battery of the present invention has a positive electrode and a negative electrode, wherein the negative electrode comprises: a solid electrolyte; and a first negative electrode active material of spinel type Li_{4-a-c}Ti_{5-b}M¹_{a+b}O_{12-δ}(M¹ is at least one element selected from the group consisting of Li, Na, K, Mg, Ca, Al, Zn, and transition metal elements, and −1≤a≤0.5, 0≤b=0.5, 0≤c≤0.5, −0.2≤δ≤1); and a second negative electrode active material of at least one kind selected from the group consisting of M²ₓNb₁₋ₓ O_{2.5-θ}, and M³_{y}M⁴_{1-y}O_{3-η}. (each of M² and M³ is at least one element selected from the group consisting of Li, Na, K, Mg, Ca, Al, Zn, and transition metal elements, and M⁴ is at least one of W and Mo, and 0≤x≤0.8, 0≤y≤1.0, 0≤θ≤1.0, 0≤η≤1.0), wherein when the total amount of the first negative electrode active material and the second negative electrode active material contained in the negative electrode is assumed as 100 volume %, the proportion of the second negative electrode active material is 5 volume % or more,
wherein when M²ₓNb₁₋ₓO_{2.5-θ} is contained as the second negative electrode active material, the proportion thereof is 95 volume % or less, wherein when M³_{y}M⁴_{1-y}O_{3-η} is contained as the second negative electrode active material, the proportion thereof is 25 vol % or less.

### Effects of the Invention

The present invention can provide a lithium ion secondary battery that is easy to detect the remaining capacity by a detection means using a voltage detection method.

### BRIEF DESCRIPTION OF THE DRAWINGS

FIG. 1 is a cross-sectional view schematically showing a example of the lithium ion secondary battery of the present invention.

FIG. 2 is a plan view schematically showing another example of the lithium ion secondary battery of the present invention.

FIG. 3 is a cross-sectional view taken along line I-I of FIG. 2.

FIG. 4 is a graph showing the relationship between h/S and Z in the lithium ion secondary batteries of Example 1 (Example 1-1) and Comparative Examples 1 to 3 and 5.

FIG. 5 is a graph showing the relationship between h/S and Z in the lithium ion secondary batteries of Examples 2 to 13 and Comparative Example 5.

FIG. 6 is a graph showing the relationship between h/S and Z in each of the lithium ion secondary batteries of Examples 14 to 17 and Comparative Example 5.

### EMBODIMENTS TO CARRY OUT THE INVENTION

The lithium ion secondary battery has a positive electrode and a negative electrode, wherein the negative electrode comprises: a solid electrolyte; and a first negative electrode active material of spinel type Li_{4-a-c}Ti_{5-b}M¹_{a+b}O_{12-δ}(M¹ is at least one element selected from the group consisting of Li, Na, K, Mg, Ca, Al, Zn, and transition metal elements, and −1≤a≤0.5, 0≤b=0.5, 0≤c≤0.5, −0.2≤δ≤1); and a second negative electrode active material of at least one kind selected from the group consisting of M²ₓNb₁₋ₓ O_{2.5-θ}, and M³_{y}M⁴_{1-y}O_{3-η}(M² and M³ are at least one element selected from the group consisting of Li, Na, K, Mg, Ca, Al, Zn, and transition metal elements, and M⁴ is at least one of W and Mo, and −1≤x≤0.8, 0≤y≤1.0, 0≤θ≤1.0, −0≤η≤1.0)), wherein when the total amount of the first negative electrode active material and the second negative electrode active material contained in the negative electrode is assumed as 100 volume %, the proportion of the second negative electrode active material is 5 volume % or more, wherein when M²ₓNb₁₋ₓO_{2.5-θ} is contained as the second negative electrode active material, the proportion thereof is 95 volume % or less, wherein when M³_{y}M⁴_{1-y}O_{3-η} is contained as the second negative electrode active material, the proportion thereof is 25 vol % or less.

That is, the lithium ion secondary battery of the present invention contains a solid electrolyte, a first negative electrode active material which is a spinel-type lithium titanium oxide, and at least one of the specific active materials as a second negative electrode active material, and the ratio of the first negative electrode active material to the second negative electrode active material is within a specific range.

The second negative electrode active material is a material whose charging curve has a gentler slope than the first negative electrode active material. In the lithium ion secondary battery of the present invention, the action of the second negative electrode active material makes it possible to suppress the phenomenon of a sudden voltage drop when the remaining capacity becomes low and the phenomenon of the voltage drop becoming extremely small, which were problems when using lithium titanium oxide as the first negative electrode active material, despite the fact that the negative electrode contains a solid electrolyte, and therefore, this makes it possible to easily detect the remaining capacity using a detection means that utilizes a voltage detection method.

On the other hand, when the second negative electrode active material is used, problems due to polarization in the thickness direction of the negative electrode tend to occur. However, in the present invention, the occurrence of such problems can be suppressed by the action of the first negative electrode active material. As a result, for example, a lithium ion secondary battery with excellent load characteristics can be obtained.

When element M² in M²ₓNb₁₋ₓO_{2.5-θ} is a transition metal element, element M² is preferably Ti, V, Cr, Mn, Fe, Co, Ni, Cu, Zr, Mo, Ag, La, Ce, or W. Also, when element M³ in M³_{y}M⁴_{1-y}O_{3-η} is a transition metal element, element M³ is preferably Ti, V, Cr, Mn, Fe, Co, Ni, Cu, Zr, Mo, Nb, Ag, La, or Ce.

Specific examples of M²ₓNb₁₋ₓO_{2.5-θ} include TiNb₂O₇, CU_{0.2}Al_{0.74}Nb_{11.1}O_{27.9}, TiNb₂O₇, Cu_{0.2}Al_{0.74}Nb_{11.1}O_{27.9}, AlNb₁₁O₂₉, Nb₁₂O₂₉, Zn₂Nb₃₄O₈₇, Cu_{0.02}Ti_{0.94}Nb_{2.04}O₇, Ti₂Nb₁₀O₂₉, Ti₂Nb₁₀O_{27.1}, TiNb₆O₁₇, Cr_{0.6}Ti_{0.8}Nb_{10.6}O₂₉, TiNb₂₄O₆₂, Cu₂Nb₃₄O₈₇, FeNbO₂₉, Cr_{0.2}Fe_{0.8}NbnO₂₉, Al_{0.2}Fe_{0.8}Nb₁₁O₂₉, ZrNb₁₄O₃₇, Mg₂Nb₃₄O₈₇, K₂Nb₈O₂₁, Cr_{0.5}Nb_{24.5}O₆₂, K₆Nb_{10.8}O₃₀, etc. Specific examples of M³_{y}M⁴_{1-y}O_{3-η} include W₁₈O₄₉, WO₃, WNb₁₂O₃₃, W₃Nb₁₄O₄₄, W₅Nb₁₆O₅₅, W₈Nb₁₈O₆₉, WNb₂O₈, W₁₆Nb₁₈O₉₃, W_{10.3}Nb_{6.7}O₄₇, W₇Nb₄O₃₁, MoO₃, and MoO₂.

Specific examples of the first negative electrode active material include Li₄Ti₅O₁₂, Li₄Ti₅₋ₓ MoₓO₁₂ (x=0.1, 0.15). Ba_{0.005}Li_{3.9990} Ti₅O₁₂, Sr_{0.005}Li_{3.9990}Ti₅O₁₂, and Li_{3.8}Fe_{0.3}Ti_{4.9}O₁₂.

Hereinafter, regarding the second negative electrode active materials, M²ₓNb₁₋ₓO_{2.5-θ} may be referred to as the “second negative electrode active material (a),” and M³_{y}M⁴_{1-y}O_{3-η} may be referred to as the “second negative electrode active material (b).”

The negative electrode may contain only one of the second negative electrode active material (a) and the second negative electrode active material (b) as the second negative electrode active material, or may contain two or more of them. Also, the negative electrode may contain only one kind of the second negative electrode active material (a) or two or more kinds. Furthermore, the negative electrode may contain only one kind of the second negative electrode active material (b) or two or more kinds.

According to the present invention, as described above, it is possible to suppress a sudden voltage drop phenomenon or a phenomenon in which the voltage drop becomes extremely small when the remaining capacity of a lithium ion secondary battery becomes low. Specifically, it is possible to ensure the characteristic when the following ΔE1, ΔE2, and ΔE3 satisfy the relationships of the following formulas (4) and (5).

2≤ΔE2/ΔE1≤20 (4)

0.2ΔE3/ΔE2≤2 (5)

Here, ΔE1 is the difference between the open circuit voltage at a state of charge of 30% and the open circuit voltage at a charge depth of 20%; ΔE2 is the difference between the open circuit voltage at a charge depth of 20% and the open circuit voltage at a charge depth of 10%; and ΔE3 is the difference between the open circuit voltage at a charge depth of 10% and the open circuit voltage at a charge depth of 5%. It is preferable that ΔE1 is 5 mV or more and 110 mV or less.

In this specification, the state of charge (SOC) refers to the state of charge of a battery in a charge/discharge cycle after the initial discharge, with a fully charged state defined as 100% and a fully discharged state defined as 0%.

In addition, in the lithium ion secondary batteries, it is preferable that the ratio of ΔE1 to ΔE2, ΔE2/ΔE1 is 20 or less. In this case, the voltage drop between SOCs of 30% and 10% can be made gradual enough to make it easy to detect the remaining capacity using a detection means that uses a voltage detection method. However, if ΔE2/ΔE1 is too small, the voltage drop between SOCs of 30% and 10% will be too small, which may make it difficult to detect the remaining capacity using a detection means that uses a voltage detection method. Therefore, it is preferable that ΔE2/ΔE1 is 2 or more.

Furthermore, in the lithium ion secondary batteries, it is preferable that the ratio of ΔE2 to ΔE3, ΔE3/ΔE2 is 2 or less. In this case, the voltage drop at the stage where the SOC is 20% or less can be made gradual enough to make it easy to detect the remaining capacity using a detection means that utilizes a voltage detection method. However, if ΔE3/ΔE2 is too small, the voltage drop at the stage where the SOC is 20% or less will be too small, which may make it difficult to detect the remaining capacity using a detection means that utilizes a voltage detection method. Therefore, it is preferable that ΔE3/ΔE2 is 0.2 or more.

The lithium ion secondary battery of the present invention has a negative electrode containing a solid electrolyte. Such a negative electrode is preferably applied to an all-solid-state secondary battery that typically has a solid electrolyte instead of a non-aqueous electrolyte and a separator, and the positive electrode also contains a solid electrolyte. Therefore, the preferred embodiment of the lithium ion secondary battery of the present invention is an all-solid-state secondary battery. Next, a detailed description will be given of the case where the lithium ion secondary battery of the present invention is an all-solid-state secondary battery.

### <Negative Electrode>

For example, the negative electrode has a structure in which a layer of a negative electrode composition (negative electrode composition layer) containing a negative electrode active material (first negative electrode active material and second negative electrode active material) is provided on one or both sides of a negative electrode current collector, or can be made of a molded body of a negative electrode composition containing a negative electrode active material (such as a pellet).

The negative electrode active material includes a first negative electrode active material and a second negative electrode active material, but may also include a negative electrode active material other than the first negative electrode active material and the second negative electrode active material.

The examples of the negative electrode active materials other than the first negative electrode active material and the second negative electrode active material include negative electrode active materials used in general lithium ion secondary batteries which are other than the various active materials exemplified above as specific examples of the first negative electrode active material, spinel type Li_{4-a-c} Ti_{5-b}M¹_{a+b}O_{12-δ} and the second negative electrode active material.

In the lithium ion secondary battery, from the viewpoint of suppressing a sudden voltage drop phenomenon at the time when the remaining capacity becomes low by adjusting, for example, the relationship the formula (4) and the formula (5) to satisfy, when the total amount of the first negative electrode active material and the second negative electrode active material contained in the negative electrode is assumed as 100 vol %, the proportion of the second negative electrode active material (when two or more kinds of active materials are used as the second negative electrode active material, the total amount of them) is 5 vol % or more, and preferably 10 vol % or more (i.e., the proportion of the first negative electrode active material is 95 vol % or less, and preferably 90 vol % or less).

Furthermore, in the lithium ion secondary battery, for example, from the viewpoint of adjusting the relationship the formula (4) and the formula (5) to satisfy and increasing the degree of voltage drop to a certain extent when the remaining capacity becomes low, and suppressing the problems that may be caused by the second negative electrode active material by the action of the first negative electrode active material and ensuring good load characteristics, it is desirable that the proportion of the second negative electrode active material be as follows when the total amount of the first negative electrode active material and the second negative electrode active material contained in the negative electrode is taken as 100 volume %.

When the second negative electrode active material (a) is contained, the proportion thereof is 95 vol % or less, and preferably 90 vol % or less. Furthermore, when the second negative electrode active material (b) is contained, its proportion is 25 vol % or less, and preferably 20 vol % or less. The total proportion of the second negative electrode active material (when two or more kinds of the second negative electrode active material (a) and the second negative electrode active material (b) are used in combination as the second negative electrode active material, the total proportion) is preferably 95 vol % or less, and more preferably 90 vol % or less (i.e., the proportion of the first negative electrode active material is preferably 5 vol % or more, and more preferably 10 vol % or more).

When the total amount of the negative electrode active materials contained in the negative electrode is taken as 100% by volume, the total ratio of the first negative electrode active material and the second negative electrode active material is preferably 40% by volume or more. Therefore, when a negative electrode active material other than the first negative electrode active material and the second negative electrode active material is used, it is preferable to use the first negative electrode active material and the second negative electrode active material in a range that satisfies the above value.

The content of all the negative electrode active materials in the negative electrode composition is preferably 10 to 99 mass %.

The negative electrode composition can contain a conductive assistant. Specific examples of the conductive assistants include carbon materials such as graphite (natural graphite, artificial graphite), graphene, carbon black, carbon nanofibers, and carbon nanotubes. When a conductive assistant is contained in the negative electrode composition, the content is preferably 1 to 15 mass %.

The negative electrode composition contains a solid electrolyte. The solid electrolyte is not particularly limited as long as it has Li ion conductivity, and examples that can be used include sulfide-based solid electrolytes, hydride-based solid electrolytes, halide-based solid electrolytes, and oxide-based solid electrolytes.

Examples of sulfide-based solid electrolytes include particles of Li₂S—P₂S₅, Li₂S—SiS₂, Li₂S—P₂S₅—GeS₂, and Li₂S—B₂S₃-based glass. Additionally, the example that have been attracting attention in recent years for their high Li-ion conductivity can include: thio-LISICON-type electrolytes such as Li₁₀GeP₂S₁₂, Li_{9.56}Si_{1.74}P_{1.44}S_{11.7}Cl_{0.3}, etc., which can be expressed as Li_{12-12a-b+c+6d-e} M¹_{3+a-b-c-d} M²_{b}M³_{c}M⁴_{d}M⁵₁₂₋ₑXₑ (where M¹ is Si, Ge or Sn, M² is P or V, M³ is Al, Ga. Y or Sb, M⁴ is Zn, Ca or Ba, M⁵ is S or S and O, and X is F, Cl, Br or I, 0≤a<3, 0≤b+c+d≤3, 0≤e≤3); and an argyrodite type compound such as Li₆PS₅Cl, which can be expressed as Li_{7-f+g}PS₆₋ₓ Cl_{x+y}(where 0.05≤f≤0.9, −3.0f+1.8≤g≤−3.0f+5.7), and Li₇₋ₕPS₆₋ₕClᵢBrⱼ (where h=i+j, 0≤h≤1.8, 0.1≤i/j≤10.0)) can also be used.

Examples of a hydride-based solid electrolytes include LiBH₄, solid solutions of LiBH₄ and the following alkali metal compounds (for example, those in which the molar ratio of LiBH₄ to the alkali metal compound is 1:1 to 20:1), and the like. An alkali metal compound in the solid solution can be at least one selected from the group consisting of lithium halides (LiI, LiBr, LiF, LiCl, etc.), rubidium halides (RbI, RbBr, RbF, RbCl, etc.), cesium halides (CsI, CsBr, CsF, CsCl, etc.), lithium amide, rubidium amide, and cesium amide.

Examples of halide-based solid electrolytes include monoclinic LiAlCl₄, defective spinel or layered structure LiInBr₄, and monoclinic Li₆₋₃ₘYₘX₆ (where 0<m<2 and X═Cl or Br), and other known solid electrolytes that can be used include those described in, for example, WO 2020/070958 and WO 2020/070955.

Examples of oxide-based solid electrolytes include Li₂O—Al₂O₃—SiO₂—P₂O₅—TiO₂ type glass ceramics, Li₂O—Al₂O₃—SiO₂—P₂O₅—GeO₂ type glass ceramics, garnet-type Li₇La₃Zr₂O₁₂. NASICON type Li₁₊ₒAl₁₊ₒTi₂₋ₒ(PO₄)₃, Li₁₊ₚAl₁₊ₚGe₂₋ₚ(PO₄)₃, and perovskite type Li_{3q}La_{2/3-q}TiO₃.

Among these solid electrolytes, sulfide-based solid electrolytes are preferred because of their high Li ion conductivity, sulfide-based solid electrolytes containing Li and P are more preferred, and argyrodite type sulfide-based solid electrolytes, which have particularly high Li ion conductivity and high chemical stability, are even more preferred.

From the viewpoint of reducing grain boundary resistance, the average particle size of the solid electrolyte is preferably 0.1 μm or more, and more preferably 0.2 μm or more, while from the viewpoint of forming a sufficient contact interface between the positive electrode active material and the solid electrolyte, the average particle size is preferably 10 μm or less, and more preferably 5 μm or less.

The average particle diameter of the solid electrolyte and other particles (such as the positive electrode active material) referred to in this specification means the 50% diameter value (D₅₀) in the volume-based integrated fraction when the integrated volume is determined from particles with small particle sizes using a particle size distribution measurement device (such as a Microtrac particle size distribution measurement device “HRA9320” manufactured by Nikkiso Co., Ltd.).

The content of the solid electrolyte in the negative electrode composition is preferably 4 to 60 mass %.

The negative electrode composition can contain a binder. Specific examples include fluororesins such as polyvinylidene fluoride (PVDF). In addition, in the case where good moldability can be ensured in the negative electrode composition without using a binder, for example, when the negative electrode composition contains a sulfide-based solid electrolyte, the negative electrode composition does not need to contain a binder.

When a binder is required in the negative electrode composition, the content thereof is preferably 15% by mass or less, and is preferably 0.5% by mass or more. On the other hand, in the case where good moldability can be obtained in the negative electrode composition without the need for a binder, the content is preferably 0.5 mass % or less, more preferably 0.3 mass % or less, and even more preferably 0 mass % (i.e., no binder is contained).

When a current collector is used for the negative electrode, the current collector can be made of a foil, a punched metal, a net, an expanded metal, or a foamed metal of copper or nickel; carbon sheet: or the like.

For example, the negative electrode can be manufactured through a process of forming a molded body of the negative electrode composition by compressing, by pressure molding or the like, a negative electrode composition prepared by mixing a first negative electrode active material, a second negative electrode active material, and a solid electrolyte, and further a negative electrode active material other than the first negative electrode active material and the second negative electrode active material, a conductive assistant, a binder, and the like, which are added as necessary.

In the case of a negative electrode having a molded body of a negative electrode composition, it can be used as a negative electrode as it is, or it can be bonded to a current collector by, for example, pressure bonding, to produce a negative electrode having a layer (negative electrode composition layer) composed of the molded body of a negative electrode composition on one or both sides of the negative electrode current collector.

In addition, in the case of a negative electrode having a current collector, it can be formed by the following method. A negative electrode composition mixture (paste, slurry, etc.) in which the above-mentioned negative electrode composition is dispersed in a solvent is applied to a current collector, dried, and then, if necessary, pressure molding such as calendaring is performed to form a negative electrode composition layer on the surface of the current collector.

The solvent for the negative electrode composition mixture can be water or an organic solvent such as N-methyl-2-pyrrolidone (NMP). When the negative electrode composition mixture also contains a solid electrolyte, it is preferable to select a solvent that does not easily deteriorate the solid electrolyte. In particular, since sulfide-based solid electrolytes and hydride-based solid electrolytes undergo chemical reactions in the presence of minute amounts of water, it is preferable to use non-polar aprotic solvents such as hydrocarbon solvents such as hexane, heptane, octane, nonane, decane, decalin, toluene, xylene, mesitylene, and tetralin. In particular, it is more preferable to use an ultra-dehydrated solvent having a water content of 0.001% by mass (10 ppm) or less. In addition, the example thereof to be used can include fluorine-based solvents such as “Vertrel (registered trademark)” manufactured by Du Pont-Mitsui Fluorochemicals Co. Ltd., “Zeorolla (registered trademark)” manufactured by Zeon Corporation, and “Novec (registered trademark)” manufactured by Sumitomo 3M Limited, as well as non-aqueous organic solvents such as dichloromethane, diethyl ether, and anisole,

The thickness of the molded body of the negative electrode composition formed by pressure molding is usually 50 μm or more, but from the viewpoint of increasing the capacity of the battery, it is preferably 200 μm or more. The thickness of the molded body of the negative electrode composition is usually 3,000 μm or less, and from the viewpoint of improving the load characteristics of the battery, it is preferably 500 μm or less.

Furthermore, in the case of a negative electrode produced by forming a negative electrode composition layer on a current collector using a negative electrode composition mixture containing a solvent, the thickness of the negative electrode composition layer (the thickness per one side of the current collector) is preferably 50 to 1,000 μm.

Compared with lithium titanium oxide (first negative electrode active material) that exhibits a two-phase coexistence reaction type lithium ion absorption behavior, the second negative electrode active material exhibits a solid solution type lithium ion absorption behavior, and therefore tends to have a large polarization in the thickness direction of the electrode (except when the second negative electrode active material exhibits better output characteristics than the spinel type lithium titanium oxide). Therefore, when the total volume of the first negative electrode active material and the second negative electrode active material contained in the negative electrode is 100 volume %, as the ratio Z (volume %) of the second negative electrode active material increases, it is preferable to design a battery such that the thickness of the negative electrode (if a current collector is present, it means the thickness of the negative electrode composition layer or the molded body of the negative electrode composition excluding the current collector. The same standard applies hereinafter.) is thinner and the area of the positive electrode and negative electrode facing each other is wider.

For example, in a battery described later (see Examples), in order to realize favorable load characteristics (a capacity retention rate of 80% or more of a discharge capacity at a discharge current of 0.5 C relative to a discharge capacity at a discharge current of 0.05 C), a specific relationship is established between the ratio h/S of the area S (cm²) where the positive electrode and the negative electrode face each other to the thickness h (cm) of the negative electrode, and the proportion Z (volume %) of the second negative electrode active material in the total volume of the first negative electrode active material and the second negative electrode active material: 100 volume %.

Specifically, for example, when the second negative electrode active material is the second negative electrode active material (a) and the element M² is Ti, better load characteristics can be ensured when the following formula (1) is satisfied.

$$h / S < - 0.48 \times ( Z / 100 ) + 0.3 \qquad ( 1 )$$

When the second negative electrode active material is the second negative electrode active material (a) and the element M² contains at least Al, better load characteristics can be ensured if the following formula (2) is satisfied.

$$h / S < - 0.35 \times ( Z / 100 ) + 0.3 \qquad ( 2 )$$

Furthermore, when the second negative electrode active material is the second negative electrode active material (b), better load characteristics can be ensured if the following formula (3) is satisfied.

$$h / S < - 0.34 \times ( Z / 100 ) + 0.3 \qquad ( 3 )$$

The slope “−0.48” in the formula (1), the slope “−0.35” in the formula (2), and the slope “−0.34” in the formula (3) are all values determined by the combination of materials used in the negative electrode and the manufacturing conditions of the negative electrode. When a negative electrode active material having the same load characteristics as the spinel-type lithium titanium oxide, which is the first negative electrode active material, is used in combination with a second negative electrode active material, the slopes of the right-hand sides of the formulas (1), (2), and (3) are 0. When a negative electrode active material having better load characteristics than the first negative electrode active material is used in combination with a second negative electrode active material, the slopes of the right-hand sides of the formulas (1), (2), and (3) are greater than 0. Therefore, there is no restriction on the ratio h/S due to the load characteristics of the negative electrode active material. However, in the case of the second negative electrode active material of the battery of the present invention, as described above, the load characteristics are inferior to those of the first negative electrode active material. Therefore, in order to achieve predetermined load characteristics in the battery, it is preferable to design the battery so that h/S satisfies the formula (1), the formula (2), or the formula (3) depending on the type of the second negative electrode active material.

The ratio h/S is preferably equal to or greater than 0.001, and more preferably equal to or greater than 0.05.

Furthermore, the proportion C of the solid electrolyte in the apparent volume of the negative electrode (100 volume %) is preferably 20 volume % or more, more preferably 40 volume % or more, and is preferably 65 volume % or less, and more preferably 55 volume % or less.

The proportion C of the solid electrolyte in the apparent volume of the negative electrode can be estimated from a composition analysis of each component by SEM-EDS observation of a cross section of the negative electrode (negative electrode composition layer or a molded body of the negative electrode composition), an average composition analysis of the negative electrode by an ICP optical emission spectroscopy (ICP-OES), and the literature value of the true density of each component. The volune fraction of the first negative electrode active material and the second negative electrode active material (proportion Z of the second negative electrode active material) can be determined in a similar manner. The apparent volume of the negative electrode means the entire volume of the negative electrode composition layer or the molded body of the negative electrode composition, including pores (excluding a current collector, if any).

### <Positive Electrode>

The positive electrode can be, for example, a structure having a layer of a positive electrode composition containing a positive electrode active material (positive electrode composition layer) on one or both sides of a positive electrode current collector, or a molded body of a positive electrode composition containing a positive electrode active material (pellets, etc.).

There are no particular limitations on the positive electrode active material that can be used as long as it is a positive electrode active material used in conventionally known lithium ion secondary batteries, that is, an active material that can absorb and release Li ions. In addition, even if a positive electrode active material that causes a sudden voltage drop at the end of discharge is used in the lithium ion secondary battery of the present invention, the action of the negative electrode can suppress a sudden voltage drop even if the remaining capacity becomes small. Therefore, in the lithium ion secondary battery of the present invention, the effect is more pronounced when a positive electrode active material that causes a sudden voltage drop at the end of discharge is used.

Specific examples of positive electrode active materials that undergo a sudden voltage drop at the end of discharge include LiCoO₂, LiNiO₂, LiMn₂O₄, LiNi_{0.5}Mn_{1.5}O₄, LiCoMnO₄, LiFePO₄, LiCoPO₄, and Li₂CoP₂O₇. As the positive electrode active material, for example, only one of the above examples can be used, or two or more of them can be used in combination.

As described below, the positive electrode composition can contain a solid electrolyte, and the average particle size of the positive electrode active material contained in the positive electrode composition is preferably 1 μm or more, more preferably 2 μm or more, and preferably 30 μm or less, and more preferably 10 μm or less. The positive electrode active material can be primary particles or secondary particles formed by agglomeration of primary particles. When a positive electrode active material with an average particle size within the above range is used, a large interface with the solid electrolyte contained in the positive electrode can be obtained, thereby further improving the load characteristics of the battery.

In addition, from the viewpoint of better suppressing side reactions of the solid electrolyte, the positive electrode active material contained in the positive electrode composition containing a solid electrolyte preferably has a reaction suppression layer on its surface for suppressing reaction with the solid electrolyte.

The reaction suppression layer can be made of a material that has ion conductivity and can suppress the reaction between the positive electrode active material and the solid electrolyte. Examples of materials that can form the reaction suppression layer include oxides containing Li and at least one element selected from the group consisting of Nb, P, B, Si, Ge, Ti, Zr, Ta, and W, more specifically, e.g., Nb-containing oxides such as LiNbO₃, Li₃PO₄, Li₃BO₃, Li₄SiO₄, Li₄GeO₄, LiTiO₃, LiZrO₃, and Li₂WO₄. The reaction suppression layer can contain only one of these oxides, or two or more of these oxides, which further can form a composite compound of two or more of these oxides. Among these oxides, it is preferable to use an Nb-containing oxide, and it is more preferable to use LiNbO₃.

The reaction suppression layer is preferably present on the surface in an amount of 0.1 to 2.0 parts by mass per 100 parts by mass of the positive electrode active material. Within this range, the reaction between the positive electrode active material and the solid electrolyte can be effectively suppressed.

The methods for forming a reaction suppression layer on the surface of the positive electrode active material include the sol-gel method, mechanofusion method, CVD method, PVD method, and ALD method.

The content of the positive electrode active materials in the positive electrode composition is preferably 20 to 95 mass %.

The positive electrode composition can contain a conductive assistant. Specific examples thereof include the same conductive assistants as those exemplified above as those that can be contained in the negative electrode composition. The content of the conductive assistant particles in the positive electrode composition is preferably 1 to 10 mass %.

The positive electrode composition can contain a binder. Specific examples include the same binders as those exemplified above as those that can be contained in the negative electrode composition. In addition, in the case where good moldability can be ensured in the positive electrode composition without using a binder, for example, when the positive electrode composition contains a sulfide-based solid electrolyte, the positive electrode composition does not need to contain a binder.

When a binder is required in the positive electrode composition, the content thereof is preferably 15% by mass or less, and is preferably 0.5% by mass or more. On the other hand, in the case where good moldability can be obtained in the positive electrode composition without the need for a binder, the content is preferably 0.5 mass % or less, more preferably 0.3 mass % or less, and even more preferably 0 mass % (i.e., no binder is contained).

The positive electrode composition can contain a solid electrolyte. Specific examples thereof include the same solid electrolytes as those exemplified above as those that can be contained in the negative electrode composition. Among the above-listed solid electrolytes, it is more preferable to use a sulfide-based solid electrolyte, since it has high lithium ion conductivity and also has a function of enhancing the moldability of the positive electrode composition.

When the positive electrode composition contains a solid electrolyte, the content thereof is preferably 4 to 80 mass %.

When the positive electrode has a current collector, the current collector can be made of a metal foil, a punched metal, a mesh, an expanded metal, or a foamed metal of e.g., aluminum, nickel or stainless steel: or a carbon sheet.

The positive electrode can be manufactured, for example, through a process in which a positive electrode composition prepared by mixing a positive electrode active material, and further, if necessary, a conductive assistant, a solid electrolyte, a binder, and the like, is compressed by pressure molding or the like to form a molded body of the positive electrode composition.

In the case of a positive electrode having a molded body of a positive electrode composition, it can be used as a positive electrode as it is, or it can be bonded to a current collector by, for example, pressure bonding, to produce a positive electrode having a layer (positive electrode composition layer) composed of the molded body of a positive electrode composition on one or both sides of the positive electrode current collector.

In addition, in the case of a positive electrode having a current collector, it can be formed by the following method. A positive electrode composition mixture (paste, slurry, etc.) in which the above-mentioned positive electrode composition is dispersed in a solvent is applied to a current collector, dried, and then, if necessary, pressure molding such as calendaring is performed to form a positive electrode composition layer on the surface of the current collector.

The thickness of the molded body of the positive electrode composition formed by pressure molding is usually 50 μm or more, but from the viewpoint of increasing the capacity of the battery, it is preferably 200 μm or more. The thickness of the molded body of the positive electrode composition is usually 3,000 μm or less, and from the viewpoint of improving the load characteristics of the battery, it is preferably 500 μm or less.

Furthermore, in the case of a positive electrode produced by forming a positive electrode composition layer on a current collector by using a positive electrode composition mixture containing a solvent, the thickness of the positive electrode composition layer (the thickness per one side of the current collector) is preferably 50 to 1,000 μm.

### (Solid Electrolyte Layer)

When the lithium ion secondary battery is an all-solid-state secondary battery, the solid electrolyte in the solid electrolyte layer interposed between the positive electrode and the negative electrode can be of one or more of the various sulfide-based solid electrolytes, hydride-based solid electrolytes, halide-based solid electrolytes, and oxide-based solid electrolytes exemplified above as usable for the negative electrodes. However, in order to improve the battery characteristics, it is preferable to contain a sulfide-based solid electrolyte, and it is more preferable to contain an argyrodite type sulfide-based solid electrolyte. It is more preferable that all of the positive electrode, the negative electrode and the solid electrolyte layer contain a sulfide-based solid electrolyte, and it is even more preferable that they contain an argyrodite type sulfide-based solid electrolyte.

The solid electrolyte layer can be provided with a porous body such as a resin nonwoven fabric as a support.

The solid electrolyte layer can be formed by: e.g., a method of compressing a solid electrolyte by pressure molding; and a method of applying a composition for forming a solid electrolyte layer, which is prepared by dispersing a solid electrolyte in a solvent, onto a substrate (including a porous body serving as a support), a positive electrode, or a negative electrode, followed by drying the composition, and, if necessary, performing pressure molding such as pressing.

As a solvent used in the composition for forming a solid electrolyte layer, it is desirable to select such a solvent that is unlikely to deteriorate the solid electrolyte. It is preferable to use the same solvent as the various solvents exemplified above as the solvent for the negative electrode composition mixture containing a solid electrolyte.

The thickness of the solid electrolyte layer is preferably 10 to 500 μm.

### <Electrode Body>

The positive and negative electrodes can be used in a battery in the form of a laminated electrode body in which they are laminated with a solid electrolyte layer between them, or in the form of a wound electrode body in which the laminated electrode body is wound.

When forming an electrode body having a solid electrolyte layer, it is preferable to do a pressure molding of the positive electrode, negative electrode, and solid electrolyte layer in a laminated state from the viewpoint of increasing the mechanical strength of the electrode body.

### <Configuration of Lithium Ion Secondary Battery>

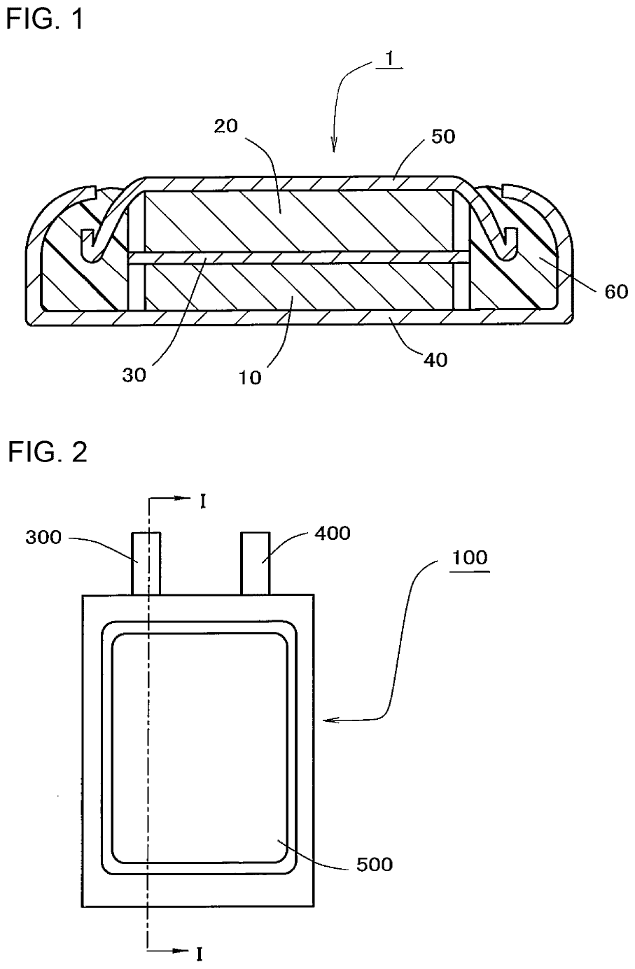

FIG. 1 shows a cross-sectional view that schematically shows an example of the lithium ion secondary battery of the present invention. The lithium ion secondary battery 1 shown in FIG. 1 has a positive electrode 10, a negative electrode 20, and a solid electrolyte layer 30 that is interposed between the positive electrode 10 and the negative electrode 20 enclosed within an exterior body formed of an exterior can 40, a sealing can 50, and a resin gasket 60 that is interposed between them.

The sealing can 50 is fitted into the opening of the exterior can 40 via a gasket 60, and the open end of the exterior can 40 is tightened inward, thereby the gasket 60 coming into contact with the sealing can 50, thereby sealing the opening of the exterior can 40 to form an airtight structure inside the battery.

The exterior can and the sealing can can be made of stainless steel or the like. In addition, polypropylene, nylon, etc. can be used as the material for the gasket. In addition, in cases where heat resistance is required in relation to the use of the battery, heat-resistant resins with melting points exceeding 240° C. can also be used, which include: fluororesins such as tetrafluoroethylene-perfluoroalkoxyethylene copolymer (PFA); polyphenylene ether (PPE); polysulfone (PSF); polyarylate (PAR); polyethersulfone (PES); polyphenylene sulfide (PPS); and polyetheretherketone (PEEK). Furthermore, when the battery is used in an application requiring heat resistance, a glass hermetic seal can be used for sealing the battery.

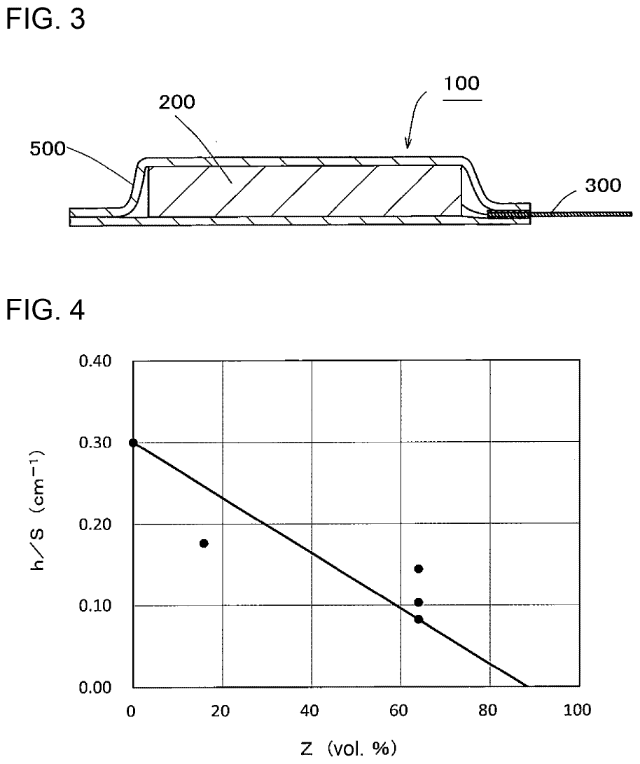

FIGS. 2 and 3 are drawings schematically showing another example of the lithium ion secondary battery of the present invention. FIG. 2 is a plan view of the lithium ion secondary battery, and FIG. 3 is a cross-sectional view taken along line I-I in FIG. 2.

The lithium ion secondary battery 100 shown in FIGS. 2 and 3 houses an electrode body 200 in a laminate film exterior body 500 made of two metal laminate films, and the laminate film exterior body 500 is sealed at its outer periphery by heat fusing the upper and lower metal laminate films.

When the lithium ion secondary battery 100 is an all-solid-state secondary battery, the electrode body 200 is configured by laminating a positive electrode, a negative electrode, and a solid electrolyte layer interposed between them.

In addition, in FIG. 3, in order to avoid complicating the drawing, the layers that make up the laminate film exterior body 500 and the components (positive electrode, negative electrode, etc.) that constitute the electrode body 200 are not distinguishably shown.

The positive electrode of the electrode body 200 is connected to a positive electrode external terminal 300 within the battery 100, and although not shown, the negative electrode of the electrode body 200 is also connected to a negative electrode external terminal 400 within the battery 100. One end of each of the positive electrode external terminal 300 and the negative electrode external terminal 400 is extended outside the laminate film exterior body 500 so as to be able to connect to an external device or the like.

### <Battery Configuration>

The configuration of the lithium ion secondary battery can be one having an exterior body composed of an exterior can, a sealing can, and a gasket as shown in FIG. 1, i.e., one generally known as a coin-type battery or button-type battery; or one having an exterior body composed of a resin film or a metal-resin laminate film as shown in FIGS. 2 and 3; or one having an exterior body made of a metal, bottomed, tubular (cylindrical or rectangular) exterior can having a sealing structure that seals the opening.

### EXAMPLES

The present invention will be described in detail below with reference to the Examples. However, it is noted that the following examples should not be used to narrowly construe the scope of the present invention.

### Example 1

### Preparation of the Positive Electrode

0.86 g of lithium and 38.7 g of pentaethoxyniobium were mixed in 394 g of dehydrated ethanol to prepare a coating solution for forming a reaction suppression layer. Next, the coating solution for forming the reaction suppression layer was applied onto 1,000 g of LiCoO₂ (a positive electrode active material) at a rate of 2 g per minute by means of a coating device using a tumbling fluidized bed. The obtained powder was heat-treated at 350° C. to form a reaction suppression layer composed of 2 parts by mass of LiNbO₃ per 100 parts by mass of LiCoO₂ on the surface of LiCoO₂.

A positive electrode composition was prepared by mixing LiCoO₂ having a reaction suppression layer formed on its surface, vapor-grown carbon fiber (conductive assistant), and Li₆PS₅Cl (sulfide-based solid electrolyte). The mixture ratio of LiCoO₂, the conductive assistant, and the sulfide-based solid electrolyte was 66:4:30 by mass. 79 mg of the positive electrode composition was placed into a powder molding die with a diameter of 7.5 mm and molded using a press at a pressure of 1,000 kgf/cm² to produce a positive electrode consisting of a cylindrical molded body of the positive electrode composition.

### <Formation of Solid Electrolyte Layer>

On the solid electrolyte layer in the powder molding die, 8 mg of the same sulfide-based solid electrolyte as that used for the positive electrode was placed, and molding was performed using a press at a pressure of 1,000 kgf/cm² to form a solid electrolyte layer on the molded body of the positive electrode composition.

### Preparation of Negative Electrode

Li₄Ti₅O₁₂ (the first negative electrode active material), W₁₈O₄₉ (the second negative electrode active material), the same sulfide-based solid electrolyte as that used in the solid electrolyte layer, and graphene (a conductive assistant) were mixed and thoroughly kneaded to prepare a negative electrode composition. In the negative electrode composition, the ratio of the negative electrode active material (the total of the first negative electrode active material and the second negative electrode active material), the sulfide-based solid electrolyte, and the graphene was 59:32:9 by mass. When the total amount of the negative electrode active material was taken as 100% by mass, the proportion of the first negative electrode active material and the proportion of the second negative electrode active material were 70% by mass and 30% by mass, respectively. When the total amount of the negative electrode active material was taken as 100% by volume, the proportion of the first negative electrode active material and the proportion of the second negative electrode active material were 84% by volume and 16% by volume, respectively.

Next, 93 mg of the negative electrode composition was poured onto the solid electrolyte layer in the powder molding die, and molding was performed using a press at a pressure of 6,000 kgf/cm² to form a negative electrode composed of the molded body of the negative electrode composition on the solid electrolyte layer, thereby obtaining a laminated electrode body in which the positive electrode, the solid electrolyte layer and the negative electrode were laminated. In the laminated electrode body as obtained, the opposing area S of the positive electrode and negative electrode was 0.454 cm², the height h of the negative electrode was 0.080 cm, and the value of h/S was 0.18 (cm⁻¹).

<Assembly of Lithium Ion Secondary Battery (all-Solid-State Secondary Battery)>

Two sheets of flexible graphite sheet “PERMA-FOIL (product name)” manufactured by Toyo Tanso Co., Ltd. (thickness: 0.1 mm, apparent density: 1.1 g/cm³) were punched out to be the same size as the laminated electrode body, and one of them was placed on the inner bottom surface of a stainless steel sealed can fitted with a polypropylene ring gasket. Next, the laminated electrode body was placed on the graphite sheet, with the negative electrode facing the graphite sheet side, onto which another graphite sheet was placed. Then, a stainless steel exterior can was placed, followed by that the open end of the exterior can was crimped inward to seal it, thereby producing a flat lithium ion secondary battery having a diameter of approximately 9 mm, in which the graphite sheets were placed between the inner bottom surface of the sealing can and the laminated electrode body, and between the inner bottom surface of the exterior can and the laminated electrode body.

The negative electrode (molded body of the negative electrode composition) in the obtained lithium ion secondary battery had an apparent volume of 0.0363 cm³, and the proportion C of the solid electrolyte was 51 volume % when the apparent volume was taken as 100 volume %.

### Comparative Example 1

The ratio of the first negative electrode active material and the ratio of the second negative electrode active material were changed to 20% by mass and 80% by mass, respectively, when the total amount of the negative electrode active material was taken as 100% by mass (the ratio of the first negative electrode active material and the ratio of the second negative electrode active material were changed to 36% by volume and 64% by volume, respectively, when the total amount of the negative electrode active material was taken as 100% by volume). In addition, the ratio of the negative electrode active material (the total of the first negative electrode active material and the second negative electrode active material), the sulfide-based solid electrolyte, and the graphene was changed to 68.5:24.8:6.7 by mass ratio. Except for the changes above, a negative electrode composition was prepared in the same manner as in Example 1. Except that 82 mg of the negative electrode composition and 83 mg of the positive electrode composition were used, a lithium ion secondary battery was fabricated in the same manner as in Example 1. The laminated electrode body in the obtained lithium ion secondary battery had a negative electrode height h of 0.065 cm and a value of h/S of 0.14 (cm⁻¹). The negative electrode (molded body of the negative electrode composition) in the obtained lithium ion secondary battery had an apparent volume of 0.0297 cm³, and the proportion C of the solid electrolyte was 51 volume % when the apparent volume was taken as 100 volume %.

### Comparative Example 2

A negative electrode composition was prepared in the same manner as in Comparative Example 1, and a lithium ion secondary battery was fabricated in the same manner as in Example 1, except that 68 mg of this negative electrode composition and 71 mg of the positive electrode composition were used. The laminated electrode body in the obtained lithium ion secondary battery had a negative electrode height h of 0.047 cm and a value of h/S of 0.10 (cm⁻¹). The apparent volume of the negative electrode (molded body of the negative electrode composition) in the obtained lithium ion secondary battery was 0.0212 cm³, and the proportion C of the solid electrolyte was 51 volume %, when the apparent volume was taken as 100 volume %.

### Comparative Example 3

A negative electrode composition was prepared in the same manner as in Comparative Example 1, and a lithium ion secondary battery was fabricated in the same manner as in Example 1, except that 54 mg of the negative electrode composition and 56 mg of the positive electrode composition were used. The laminated electrode body in the obtained lithium ion secondary battery had a negative electrode height h of 0.037 cm and a value of h/S of 0.08 (cm⁻¹). The negative electrode (molded body of the negative electrode composition) in the obtained lithium ion secondary battery had an apparent volume of 0.0170 cm³, and the proportion C of the solid electrolyte was 51 volume %, when the apparent volume was taken as 100 volume %.

### Example 2

The second negative electrode active material was changed to TiNb₂O₇ (Ti_{1/3}Nb_{2/3}O_{7/3}). The ratio of the first negative electrode active material and the ratio of the second negative electrode active material were changed to 80% by mass and 20% by mass, respectively, when the total amount of the negative electrode active materials was taken as 100% by mass (the ratio of the first negative electrode active material and the ratio of the second negative electrode active material were changed to 83% by volume and 17% by volume, respectively, when the total amount of the negative electrode active materials was taken as 100% by volume). The ratio of the negative electrode active material (the total of the first negative electrode active material and the second negative electrode active material), the sulfide-based solid electrolyte, and the graphene was changed to 52:39:9 by mass ratio. Except for the changes above, the negative electrode composition was prepared in the same manner as in Example 1. A lithium ion secondary battery was fabricated in the same manner as in Example 1, except that 82 mg of this negative electrode composition and 80 mg of the positive electrode composition were used. The laminated electrode body in the obtained lithium ion secondary battery had a negative electrode height h of 0.080 cm and a value of h/S of 0.18 (cm⁻¹). The negative electrode (molded body of the negative electrode composition) in the obtained lithium ion secondary battery had an apparent volume of 0.0363 cm³, and the proportion C of the solid electrolyte was 51 volume %, when the apparent volume was taken as 100 volume %.

### Example 3

The second negative electrode active material was changed to TiNb₂O₇. The ratio of the first negative electrode active material and the ratio of the second negative electrode active material were changed to 75% by mass and 25% by mass, respectively, when the total amount of the negative electrode active materials was taken as 100% by mass (the ratio of the first negative electrode active material and the ratio of the second negative electrode active material were changed to 79% by volume and 21% by volume, respectively, when the total amount of the negative electrode active materials was taken as 100% by volume). The ratio of the negative electrode active material (the total of the first negative electrode active material and the second negative electrode active material), the sulfide-based solid electrolyte, and the graphene was changed to 56:34:10 by mass ratio. Except for these changes, the negative electrode composition was prepared in the same manner as in Example 1. A lithium ion secondary battery was fabricated in the same manner as in Example 1, except that 82 mg of the negative electrode composition and 83 mg of the positive electrode composition were used. The laminated electrode body in the obtained lithium ion secondary battery had a negative electrode height h of 0.078 cm and a value of h/S of 0.17 (cm¹). The negative electrode (molded body of the negative electrode composition) in the obtained lithium ion secondary battery had an apparent volume of 0.0354 cm³, and the proportion C of the solid electrolyte was 51 volume %, when the apparent volume was taken as 100 volume ° %.

### Example 4

A negative electrode composition was prepared in the same manner as in Example 3. A lithium ion secondary battery was fabricated in the same manner as in Example 1, except that 69 mg of the negative electrode composition and 69 mg of the positive electrode composition were used. The laminated electrode body in the obtained lithium ion secondary battery had a negative electrode height h of 0.065 cm and a value of h/S of 0.14 (cm⁻¹). The negative electrode (molded body of the negative electrode composition) in the obtained lithium ion secondary battery had an apparent volume of 0.0295 cm³, and the proportion C of the solid electrolyte was 51 volume %, when the apparent volume was taken as 100 volume %.

### Example 5

A negative electrode composition was prepared in the same manner as in Example 3. A lithium ion secondary battery was fabricated in the same manner as in Example 1, except that 57 mg of the negative electrode composition and 58 mg of the positive electrode composition were used. The laminated electrode body in the obtained lithium ion secondary battery had a negative electrode height h of 0.055 cm and a value of h/S of 0.12 (cm⁻¹). The negative electrode (molded body of the negative electrode composition) in the obtained lithium ion secondary battery had an apparent volume of 0.0250 cm³, and the proportion C of the solid electrolyte was 51 volume %, when the apparent volume was taken as 100 volume %.

### Example 6

The second negative electrode active material was changed to TiNb₂O₇. The ratio of the first negative electrode active material and the ratio of the second negative electrode active material were changed to 66% by mass and 34% by mass, respectively, when the total amount of the negative electrode active materials was taken as 100% by mass (the ratio of the first negative electrode active material and the ratio of the second negative electrode active material were changed to 72% by volume and 28% by volume, respectively, when the total amount of the negative electrode active materials was taken as 100% by volume). The ratio of the negative electrode active material (the total of the first negative electrode active material and the second negative electrode active material), the sulfide-based solid electrolyte, and the graphene was changed to 57:34:9 by mass ratio. Except for these changes, the negative electrode composition was prepared in the same manner as in Example 1. A lithium ion secondary battery was fabricated in the same manner as in Example 1, except that 79 mg of the negative electrode composition and 87 mg of the positive electrode composition were used. The laminated electrode body in the obtained lithium ion secondary battery had a negative electrode height h of 0.075 cm and a value of h/S of 0.17 (cm¹). The negative electrode (molded body of the negative electrode composition) in the obtained lithium ion secondary battery had an apparent volume of 0.0340 cm³, and the proportion C of the solid electrolyte was 51 volume %, when the apparent volume was taken as 100 volume %.

### Example 7

A negative electrode composition was prepared in the same manner as in Example 6. A lithium ion secondary battery was fabricated in the same manner as in Example 1, except that 66 mg of the negative electrode composition and 73 mg of the positive electrode composition were used. The laminated electrode body in the obtained lithium ion secondary battery had a negative electrode height h of 0.065 cm and a value of h/S of 0.14 (cm⁻¹). The negative electrode (molded body of the negative electrode composition) in the obtained lithium ion secondary battery had an apparent volume of 0.0286 cm³, and the proportion C of the solid electrolyte was 51 volume %, when the apparent volume was taken as 100 volume %.

### Example 8

A negative electrode composition was prepared in the same manner as in Example 6. A lithium ion secondary battery was fabricated in the same manner as in Example 1, except that 56 mg of the negative electrode composition and 61 mg of the positive electrode composition were used. The laminated electrode body in the obtained lithium ion secondary battery had a negative electrode height h of 0.052 cm and an h/S value of 0.11 (cm⁻¹). The negative electrode (molded body of the negative electrode composition) in the obtained lithium ion secondary battery had an apparent volume of 0.0236 cm³, and the proportion C of the solid electrolyte was 51 volume %, when the apparent volume was taken as 100 volume %.

### Example 9

The second negative electrode active material was changed to TiNb₂O₇. The ratio of the first negative electrode active material and the ratio of the second negative electrode active material were changed to 50 mass % and 50 mass %, respectively, when the total amount of the negative electrode active materials was taken as 100 mass % (the ratio of the first negative electrode active material and the ratio of the second negative electrode active material were changed to 56 volume % and 44 volume %, respectively, when the total amount of the negative electrode active materials was taken as 100 volume %). The ratio of the negative electrode active material (the total of the first negative electrode active material and the second negative electrode active material), the sulfide-based solid electrolyte, and the graphene was changed to 58:33:9 in mass ratio. Except for these changes, the negative electrode composition was prepared in the same manner as in Example 1. A lithium ion secondary battery was fabricated in the same manner as in Example 1, except that 75 mg of the negative electrode composition and 95 mg of the positive electrode composition were used. The laminated electrode body in the obtained lithium ion secondary battery had a negative electrode height h of 0.069 cm and a value of h/S of 0.15 (cm⁻¹). The negative electrode (molded body of the negative electrode composition) in the obtained lithium ion secondary battery had an apparent volume of 0.0313 cm³, and the proportion C of the solid electrolyte was 51 volume %, when the apparent volume was taken as 100 volume %.

### Example 10

A negative electrode composition was prepared in the same manner as in Example 9. A lithium ion secondary battery was fabricated in the same manner as in Example 1, except that 62 mg of the negative electrode composition and 80 mg of the positive electrode composition were used. The laminated electrode body in the obtained lithium ion secondary battery had a negative electrode height h of 0.057 cm and an h/S value of 0.13 (cm¹). The negative electrode (molded body of the negative electrode composition) in the obtained lithium ion secondary battery had an apparent volume of 0.0259 cm³, and the proportion C of the solid electrolyte was 51 volume %, when the apparent volume was taken as 100 volume %.

### Example 11

A negative electrode composition was prepared in the same manner as in Example 9. A lithium ion secondary battery was fabricated in the same manner as in Example 1, except that 52 mg of the negative electrode composition and 67 mg of the positive electrode composition were used. The laminated electrode body in the obtained lithium ion secondary battery had a negative electrode height h of 0.048 cm and an h/S value of 0.11 (cm⁻¹). The negative electrode (molded body of the negative electrode composition) in the obtained lithium ion secondary battery had an apparent volume of 0.0218 cm³, and the proportion C of the solid electrolyte was 51 volume %, when the apparent volume was taken as 100 volume %.

### Example 12

The second negative electrode active material was changed to TiNb₂O₇. The ratio of the first negative electrode active material and the ratio of the second negative electrode active material were changed to 33 mass % and 67 mass %, respectively, when the total amount of the negative electrode active materials was taken as 100 mass % (the ratio of the first negative electrode active material and the ratio of the second negative electrode active material were changed to 39 volume % and 61 volume %, respectively, when the total amount of the negative electrode active materials was taken as 100 volume %). The ratio of the negative electrode active material (the total of the first negative electrode active material and the second negative electrode active material), the sulfide-based solid electrolyte, and the graphene was changed to 58.5:32.5:9 in mass ratio. Except for these changes, the negative electrode composition was prepared in the same manner as in Example 1. A lithium ion secondary battery was fabricated in the same manner as in Example 1, except that 49 mg of this negative electrode composition and 74 mg of the positive electrode composition were used. The laminated electrode body in the obtained lithium ion secondary battery had a negative electrode height h of 0.045 cm and a value of h/S of 0.10 (cm⁻¹). The negative electrode (molded body of the negative electrode composition) in the obtained lithium ion secondary battery had an apparent volume of 0.0204 cm³, and the proportion C of the solid electrolyte was 51 volume %, when the apparent volume was taken as 100 volume %.

### Example 13

A negative electrode composition was prepared in the same manner as in Example 12. A lithium ion secondary battery was fabricated in the same manner as in Example 1, except that 38 mg of the negative electrode composition and 56 mg of the positive electrode composition were used. The laminated electrode body in the obtained lithium ion secondary battery had a negative electrode height h of 0.035 cm and an h/S value of 0.08 (cm⁻¹). The negative electrode (molded body of the negative electrode composition) in the obtained lithium ion secondary battery had an apparent volume of 0.0159 cm³, and the proportion C of the solid electrolyte was 51 volume %, when the apparent volume was taken as 100 volume %.

### Example 14

The second negative electrode active material was changed to Cu_{0.2}Al_{0.74}Nb_{11.1} O_{27.9} (Cu_{2/120} Al_{7/120} Nb_{111/120}O_{279/120}). When the total amount of the negative electrode active materials was taken as 100 mass %, the proportions of the first negative electrode active material and the second negative electrode active material were changed to 66 mass % and 34 mass %, respectively (when the total amount of the negative electrode active materials was taken as 100 volume %, the proportions of the first negative electrode active material and the second negative electrode active material were changed to 72 vol % and 28 vol %, respectively). The ratio of the negative electrode active material (the sum of the first negative electrode active material and the second negative electrode active material), the sulfide-based solid electrolyte, and the graphene was changed to 57:34:9 by mass ratio. Except for these changes, the negative electrode composition was prepared in the same manner as in Example 1. A lithium ion secondary battery was fabricated in the same manner as in Example 1, except that 79 mg of this negative electrode composition and 87 mg of the positive electrode composition were used. The laminated electrode body in the obtained lithium ion secondary battery had a negative electrode height h of 0.075 cm and a value of h/S of 0.17 (cm⁻¹). The negative electrode (molded body of the negative electrode composition) in the obtained lithium ion secondary battery had an apparent volume of 0.0340 cm³, and the proportion C of the solid electrolyte was 51 volume %, when the apparent volume was taken as 100 volume %.

### Example 15

The second negative electrode active material was changed to Cu_{0.2}Al_{0.74}Nb_{11.1}O_{27.9} (Cu_{2/120}Al_{7/120}Nb_{111/120}O_{279/120}). When the total amount of the negative electrode active material was 100 mass %, the ratio of the first negative electrode active material and the ratio of the second negative electrode active material were changed to 33 mass % and 67 mass %, respectively (when the total amount of the negative electrode active material was 100 volume %, the ratio of the first negative electrode active material and the ratio of the second negative electrode active material were changed to 39 volume % and 61 volume %, respectively). The ratio of the negative electrode active material (the sum of the first negative electrode active material and the second negative electrode active material), the sulfide-based solid electrolyte, and the graphene was changed to 58.5:32.5:9 by mass ratio. Except for these changes, a negative electrode composition was prepared in the same manner as in Example 1. A lithium ion secondary battery was produced in the same manner as in Example 1, except that 68 mg of the negative electrode composition and 103 mg of the positive electrode composition were used. The laminated electrode body in the obtained lithium ion secondary battery had a negative electrode height h of 0.063 cm and an h/S value of 0.14 (cm⁻¹). The apparent volume of the negative electrode (molded body of the negative electrode composition) in the obtained lithium ion secondary battery was 0.0286 cm³, and the proportion C of solid electrolyte was 51 volume %, when the apparent volume was taken as 100 volume %.

### Example 16

A negative electrode composition was prepared in the same manner as in Example 15. A lithium ion secondary battery was fabricated in the same manner as in Example 1, except that 49 mg of the negative electrode composition and 74 mg of the positive electrode composition were used. The laminated electrode body in the obtained lithium ion secondary battery had a negative electrode height h of 0.045 cm and a value of h/S of 0.10 (cm⁻¹). The negative electrode (molded body of the negative electrode composition) in the obtained lithium ion secondary battery had an apparent volume of 0.0204 cm³, and the proportion C of the solid electrolyte was 51 volume %, when the apparent volume was taken as 100 volume %.

### Example 17

A negative electrode composition was prepared in the same manner as in Example 15. A lithium ion secondary battery was fabricated in the same manner as in Example 1, except that 38 mg of the negative electrode composition and 56 mg of the positive electrode composition were used. The laminated electrode body in the obtained lithium ion secondary battery had a negative electrode height h of 0.035 cm, and a value of hS of 0.08 (cm⁻¹). The negative electrode (molded body of the negative electrode composition) in the obtained lithium ion secondary battery had an apparent volume of 0.0159 cm³, and the proportion C of the solid electrolyte was 51 volume %, when the apparent volume was taken as 100 volume %.

### Comparative Example 4

A negative electrode composition was prepared in the same manner as in Example 1, except that only TiNb₂O₇ was used as the negative electrode active material, and the ratio of the TiNb₂O₇, the sulfide-based solid electrolyte, and graphene was changed to 69:25:6 by mass ratio. A lithium ion secondary battery was fabricated in the same manner as in Example 1, except that 59 mg of the negative electrode composition and 122 mg of the positive electrode composition were used. The apparent volume of the negative electrode (molded body of the negative electrode composition) in the obtained lithium ion secondary battery was 0.0218 cm³, and the proportion C of the solid electrolyte was 45% by volume, when the apparent volume was taken as 100% by volume.

### Comparative Example 5

A negative electrode composition was prepared in the same manner as in Example 1, except that only Li₄Ti₅O₁₂ was used as the negative electrode active material, and the ratio of the L₄Ti₅O₁₂, the sulfide-based solid electrolyte, and graphene was changed to 55:35:10 by mass ratio. A lithium ion secondary battery was produced in the same manner as in Example 1, except that 98 mg of the negative electrode composition and 60 mg of the positive electrode composition were used. The apparent volume of the negative electrode (molded body of the negative electrode composition) in the obtained lithium ion secondary battery was 0.0431 cm³, and the proportion C of the solid electrolyte was 51% by volume, when the apparent volume was taken as 100% by volume.

### Comparative Example 6

The second negative electrode active material was changed to Nb₂O₅. The ratio of the first negative electrode active material and the ratio of the second negative electrode active material were changed to 66% by mass and 34% by mass, respectively, when the total amount of the negative electrode active material was taken as 100% by mass. The ratio of the negative electrode active material (the total of the first negative electrode active material and the second negative electrode active material), the sulfide-based solid electrolyte, and the graphene was changed to 57:34:9 by mass ratio. Except for these changes, the negative electrode composition was prepared in the same manner as in Example 1. A lithium ion secondary battery was produced in the same manner as in Example 1, except that 79 mg of this negative electrode composition and 87 mg of the positive electrode composition were used. The negative electrode (molded body of the negative electrode composition) in the obtained lithium ion secondary battery had an apparent volume of 0.0340 cm³, and the proportion C of the solid electrolyte was 51 volume %, when the apparent volume was taken as 100 volume %.

The lithium ion secondary batteries of Examples 1 to 17 and Comparative Examples 1 to 6 were charged at a constant current of 0.05C until a predetermined voltage was reached, then charged at a constant voltage until the current reached 0.01C, and then discharged at a constant current of 0.05C until a predetermined voltage was reached, and the initial capacity of the battery (0.05C capacity) was determined. They were charged again under the same conditions as the charging conditions described above, and discharged at a constant current of 0.05C until the SOC reached a predetermined value (30%, 20%, 10% or 5%), and the open circuit voltages were then measured. Then, ΔE1. ΔE2, and ΔE3 of each battery were determined from the open circuit voltage at each SOC, and ΔE2/ΔE1 and ΔE3/ΔE2 were calculated.

The voltage during the constant current charging was up to 3.3V and 3.0V in Example 1, up to 3.3V in Comparative Examples 1 to 3, up to 3.5V in Examples 2 to 17 and Comparative Examples 4 and 6, and up to 2.8V in Comparative Example 2. The voltage during the constant current discharging was up to 1.0V.

Next, the batteries whose open circuit voltages at each SOC had been measured were charged again under the same charging conditions as above. Except that the current value was changed to 0.5C, the 0.5C capacity was measured by discharging at a constant current under the same discharging conditions as above. Then, the load characteristics of each battery were evaluated by calculating a capacity retention rate, which was calculated as a percentage by dividing the 0.5C capacity by the 0.05C capacity.

The configurations of the lithium ion secondary batteries of Examples 1 to 17 and Comparative Examples 1 to 6 are shown in Tables 1 to 4, and the evaluation results are shown in Tables 5 to 8. The numerical values in the “Ratio Z” column for “Second Negative Electrode Active Material” in Tables 1 to 4 refer to the ratio Z (volume %) of the second negative electrode active material in the total volume, 100 volume %, of the first negative electrode active material and the second negative electrode active material (the same standard applies to Table 9 described below). In addition, the “right side of formula (3)” in Table 1 refers to the value of “−0.34×(Z/100)+0.30”, which is the right side of the formula (3). The “right side of formula (1)” in Table 2 refers to the value of “−0.48×(Z/100)+0.30”, which is the right side of the formula (1). The “right side of formula (2)” in Table 3 refers to the value of “−0.35×(Z/100)+0.30”, which is the right of formula (2). In addition, in Table 5. “Example 1-1” shows the evaluation results for the lithium ion secondary battery of Example 1 when the voltage during charging was set to up to 3.3V “Example 1-2” shows the evaluation results for the lithium ion secondary battery of Example 1 when the voltage during charging was set to up to 3.0V.

TABLE 1

| | second negative electrode | | | right | Positive |
|---|---|---|---|---|---|
| | active material | | | side of | electrode |
| | | Ratio Z | h/S | formula | active |
| | Kind | (vol. %) | (cm⁻¹) | (3) | material |
| Example 1 | W₁₈O₄₉ | 16 | 0.18 | 0.25 | LiCoO₂ |
| Comparative | W₁₈O₄₉ | 64 | 0.14 | 0.11 | LiCoO₂ |
| Example 1 | | | | | |
| Comparative | W₁₈O₄₉ | 64 | 0.10 | 0.11 | LiCoO₂ |
| Example 2 | | | | | |
| Comparative | W₁₈O₄₉ | 64 | 0.08 | 0.11 | LiCoO₂ |
| Example 3 | | | | | |

TABLE 2

| | second negative electrode | | | right | Positive |
|---|---|---|---|---|---|
| | active material | | | side of | electrode |
| | | Ratio Z | h/S | formula | active |
| | Kind | (vol. %) | (cm⁻¹) | (1) | material |
| Example 2 | TiNb₂O₇ | 17 | 0.18 | 0.22 | LiCoO₂ |
| Example 3 | TiNb₂O₇ | 21 | 0.17 | 0.21 | LiCoO₂ |
| Example 4 | TiNb₂O₇ | 21 | 0.14 | 0.21 | LiCoO₂ |
| Example 5 | TiNb₂O₇ | 21 | 0.12 | 0.21 | LiCoO₂ |
| Example 6 | TiNb₂O₇ | 28 | 0.17 | 0.17 | LiCoO₂ |
| Example 7 | TiNb₂O₇ | 28 | 0.14 | 0.17 | LiCoO₂ |
| Example 8 | TiNb₂O₇ | 28 | 0.11 | 0.17 | LiCoO₂ |
| Example 9 | TiNb₂O₇ | 44 | 0.15 | 0.10 | LiCoO₂ |
| Example 10 | TiNb₂O₇ | 44 | 0.13 | 0.10 | LiCoO₂ |
| Example 11 | TiNb₂O₇ | 44 | 0.11 | 0.10 | LiCoO₂ |
| Example 12 | TiNb₂O₇ | 61 | 0.10 | 0.03 | LiCoO₂ |
| Example 13 | TiNb₂O₇ | 61 | 0.08 | 0.03 | LiCoO₂ |

TABLE 3

| | second negative electrode | | | right | Positive |
|---|---|---|---|---|---|
| | active material | | | side of | electrode |
| | | Ratio Z | h/S | formula | active |
| | Kind | (vol. %) | (cm⁻¹) | (2) | material |
| Example 14 | Cu_{0.2}Al_{0.74}Nb_{11.1}O_{27.9} | 28 | 0.17 | 0.20 | LiCoO₂ |
| Example 15 | Cu_{0.2}Al_{0.74}Nb_{11.1}O_{27.9} | 61 | 0.14 | 0.09 | LiCoO₂ |
| Example 16 | Cu_{0.2}Al_{0.74}Nb_{11.1}O_{27.9} | 61 | 0.10 | 0.09 | LiCoO₂ |
| Example 17 | Cu_{0.2}Al_{0.74}Nb_{11.1}O_{27.9} | 61 | 0.08 | 0.09 | LiCoO₂ |

TABLE 4

| | second negative electrode | | | Positive |
|---|---|---|---|---|
| | active material | | | electrode |
| | | Ratio Z | h/S | active |
| | Kind | (vol. %) | (cm⁻¹) | material |
| Comparative | TiNb₂O₇ | 100 | 0.11 | LiCoO₂ |
| Example 4 | | | | |
| Comparative | — | 0 | 0.21 | LiCoO₂ |
| Example 5 | | | | |
| Comparative | Nb₂O₅ | 28 | 0.17 | LiCoO₂ |
| Example 6 | | | | |

TABLE 5

| | ΔE1 | ΔE2/ | ΔE3/ | load characteristics |
|---|---|---|---|---|
| | (mV) | ΔE1 | ΔE2 | capacity retention rate (%) |
| Example 1-1 | 56 | 6.9 | 0.9 | 92.1 |
| Example 1-2 | 18 | 8.7 | 1.5 | 94.6 |
| Comparative | 180 | 1.1 | 0.6 | 20 |
| Example 1 | | | | |
| Comparative | 185 | 1.1 | 0.6 | 72 |
| Example 2 | | | | |
| Comparative | 188 | 1.1 | 0.6 | 80 |
| Example 3 | | | | |

TABLE 6

| | ΔE1 | ΔE2/ | ΔE3/ | load characteristics |
|---|---|---|---|---|
| | (mV) | ΔE1 | ΔE2 | capacity retention rate (%) |
| Example 2 | 18 | 3.6 | 1.1 | 94 |
| Example 3 | 48 | 3.4 | 1.6 | 86 |
| Example 4 | 53 | 3.1 | 1.9 | 91.3 |
| Example 5 | 58 | 3.4 | 2.0 | 92 |
| Example 6 | 44 | 2.4 | 1.7 | 76 |
| Example 7 | 51 | 2.3 | 1.8 | 91.5 |
| Example 8 | 50 | 2.3 | 1.8 | 93.2 |
| Example 9 | 106 | 2.0 | 1.6 | 5 |
| Example 10 | 52 | 2.5 | 1.3 | 61 |
| Example 11 | 50 | 2.4 | 1.5 | 75 |
| Example 12 | 83 | 2.7 | 1.4 | 42 |
| Example 13 | 73 | 2.9 | 1.7 | 63 |

TABLE 7

| | ΔE1 | ΔE2/ | ΔE3/ | load characteristics |
|---|---|---|---|---|
| | (mV) | ΔE1 | ΔE2 | capacity retention rate (%) |
| Example 14 | 86 | 2.0 | 1.6 | 85 |
| Example 15 | 84 | 3.0 | 1.1 | 7 |
| Example 16 | 74 | 4.0 | 1.2 | 44 |
| Example 17 | 70 | 5.0 | 1.0 | 84 |

TABLE 8

| | ΔE1 | ΔE2/ | ΔE3/ | load characteristics |
|---|---|---|---|---|
| | (mV) | ΔE1 | ΔE2 | capacity retention rate (%) |
| Comparative | 90 | 1.9 | 1.2 | 1 |
| Example 4 | | | | |
| Comparative | 11 | 1.7 | 1.4 | 96 |
| Example 5 | | | | |
| Comparative | 127 | 1.9 | 0.7 | 80 |
| Example 6 | | | | |

As shown in Tables 1 to 8, the lithium ion secondary batteries of Examples 1 to 17 all had suitable values for ΔE1, ΔE2/ΔE1, and ΔE3/ΔE2, and a sudden voltage drop was suppressed at the point where the SOC was 30% or less. Therefore, with the lithium ion secondary batteries of Examples 1 to 17, when a detection means using a voltage detection method is applied, the remaining capacity can be detected with high accuracy even at the end of discharge.

In contrast, the batteries of Comparative Examples 1 to 3 using a negative electrode in which the volume ratio of the second negative electrode active material was too large, the battery of Comparative Example 4 using only the negative electrode active material corresponding to the second negative electrode active material, the battery of Comparative Example 5 using only the first negative electrode active material Li₄Ti₅O₁₂ as the negative electrode active material, and the battery of Comparative Example 6 using Nb₂O₅ instead of the second negative electrode active material had inappropriate values for either ΔE1, ΔE2/ΔE1 or ΔE3/ΔE2 and found that these batteries were difficult to accurately detect the remaining capacity at the end of discharge.

FIG. 4 shows a graph illustrating the relationship between/S and Z for each of the lithium ion secondary batteries of Example 1 (Example 1-1) and Comparative Examples 1 to 3 and 5. The straight line in FIG. 4 represents the formula “h/S=−0.34×(Z/100)+0.30”, and the battery plotted below the straight line in the figure (the battery of Example 1) had good load characteristics, as shown in Tables 1 and 5.

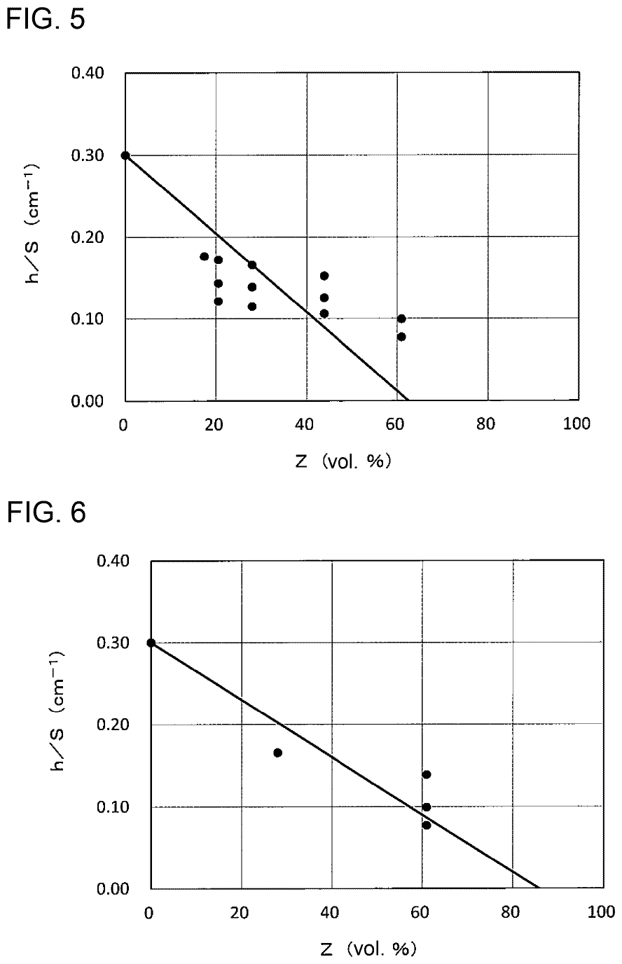

Furthermore, FIG. 5 shows a graph showing the relationship between h/S and Z in each of the lithium ion secondary batteries of Examples 2 to 13 and Comparative Example 5. The straight line in FIG. 5 represents the formula “h/S=−0.48×(Z/100)+0.30”, and the batteries plotted below the straight line in the figure (the batteries of Examples 2 to 5, 7, and 8) had good load characteristics, as shown in Tables 2 and 6.

Moreover, FIG. 6 shows a graph showing the relationship between h/S and Z for each of the lithium ion secondary batteries of Examples 14 to 17 and Comparative Example 5. The straight line in FIG. 6 represents the equation “h/S=−0.35×(Z/100)+0.30”, and the batteries plotted below this straight line in the figure (the batteries of Examples 17 and 20) had good load characteristics, as shown in Tables 3 and 7.

### Example 18

LiNi_{0.5}Mn_{1.5}O₄ was used as the positive electrode active material, and a reaction suppression layer was formed on its surface in the same manner as in Example 1. The LiNi_{0.5}Mn_{1.5}O₄, the same sulfide-based solid electrolyte as that used in the solid electrolyte layer, and graphene (conductive assistant) were mixed with each other and thoroughly kneaded to prepare a positive electrode composition. The mixing ratio of the LiNi_{0.5}Mn_{1.5}O₄, conductive assistant, and sulfide-based solid electrolyte was 70:3:27 by mass. A lithium ion secondary battery was fabricated in the same manner as in Example 1, except that 99 mg of the positive electrode composition, and 69 mg of the negative electrode composition that prepared in the same manner as in Example 2 was used.

### Example 19

LiMn₂O₄ was used as the positive electrode active material, and a reaction suppression layer was formed on its surface in the same manner as in Example 1. The LiMn₂O₄, the same sulfide-based solid electrolyte as that used in the solid electrolyte layer, and graphene (conductive assistant) were mixed with each other and thoroughly kneaded to prepare a positive electrode composition. The mixture ratio of the LiMn₂O₄, conductive assistant, and sulfide-based solid electrolyte was 70:3:27 by mass. A lithium ion secondary battery was fabricated in the same manner as in Example 1, except that 90 mg of the positive electrode composition, and 71 mg of the negative electrode composition that prepared in the same manner as in Example 2 was used.

### Comparative Example 7

A lithium ion secondary battery was fabricated in the same manner as in Example 1, except that 97 mg of the negative electrode composition prepared in the same manner as in Comparative Example 5 and 57 mg of the positive electrode composition prepared in the same manner as in Example 18 were used.

### Comparative Example 8

A lithium ion secondary battery was fabricated in the same manner as in Example 1, except that 81 mg of the negative electrode composition prepared in the same manner as in Comparative Example 5 and 77 mg of the positive electrode composition prepared in the same manner as in Example 19 were used.

For the lithium ion secondary batteries of Examples 18 and 19 and Comparative Examples 7 and 8, ΔE1, ΔE2, and ΔE3 were determined in the same manner as for the battery of Example 1, and ΔE2/ΔE1 and ΔE3/ΔE2 were calculated. The voltage during constant current charging was up to 4.2V in Example 18, up to 3.5V in Example 19 and Comparative Example 7, and up to 2.8V in Comparative Example 8. The voltage during constant current discharging was up to 1.5V in all cases.

The configurations of the lithium ion secondary batteries of Examples 18 and 19 and Comparative Examples 7 and 8 are shown in Table 9, and the evaluation results are shown in Table 10.

TABLE 9

| | second negative electrode | | | Positive |
|---|---|---|---|---|
| | active material | | | electrode |
| | | Ratio Z | h/S | active |
| | Kind | (vol. %) | (cm⁻¹) | material |
| Example 18 | TiNb₂O₇ | 17 | 0.17 | LiNi_{0.5}Mn_{1.5}O₄ |
| Example 19 | TiNb₂O₇ | 17 | 0.15 | LiMn₂O₄ |
| Comparative | — | 0 | 0.21 | LiNi_{0.5}Mn_{1.5}O₄ |
| Example 7 | | | | |
| Comparative | — | 0 | 0.17 | LiMn₂O₄ |
| Example 8 | | | | |

TABLE 10

| | ΔE1 | | |
|---|---|---|---|
| | (mV) | ΔE2/ΔE1 | ΔE3/ΔE2 |
| Example 18 | 42 | 10 | 0.6 |
| Example 19 | 82 | 3.2 | 0.9 |
| Comparative | 34 | 5.5 | 2.3 |
| Example 7 | | | |
| Comparative | 27 | 1.3 | 1.0 |
| Example 8 | | | |

As shown in Tables 9 and 10, the lithium ion secondary batteries of Examples 18 and 19 had suitable values for both ΔE2/ΔE1 and ΔE3/ΔE2, and a sudden voltage drop was suppressed at the point where the SOC was 30% or less. Therefore, with the lithium ion secondary batteries of Examples 18 and 19, when a detection means using a voltage detection method is applied, the remaining capacity can be detected with high accuracy even at the end of discharge.

In contrast, the batteries of Comparative Examples 7 and 8, in which only the first negative electrode active material Li₄Ti₅O₁₂ was used as the negative electrode active material, had inappropriate values for either ΔE2/ΔE1 or ΔE3/ΔE2, and found that these batteries were difficult to accurately detect the remaining capacity at the end of discharge.

There can be provided other embodiments than the description above without departing the gist of the present invention. The embodiment described above is an example only, and the present invention is not limited to the specific embodiment. The scope of the present invention should be construed primarily based on the claims, not to the description of the specification or the present application. Any changes within the terms of the claims and the equivalence thereof should be construed as falling within the scope of the claims.

### INDUSTRIAL APPLICABILITY

The lithium ion secondary battery of the present invention allows the remaining capacity to be easily detected by a detection means utilizing a voltage detection method, and is suitable for use as a power source for equipment equipped with such a detection means.

### EXPLANATION OF THE REFERENCE

1, 100 Lithium ion secondary battery
10 Positive electrode
20 Negative electrode
30 Solid electrolyte layer
40 Exterior can
50 Sealing can
60 Gasket
200 Electrode body
300 Positive electrode external terminal
400 Negative electrode external terminal
500 Laminate film exterior body

What is claimed is:

1. A lithium ion secondary battery having a positive electrode and a negative electrode, wherein the negative electrode comprises: a solid electrolyte; and a first negative electrode active material of spinel type Li_{4-a-c}Ti_{5-b}M¹_{a+b}O_{12-δ}(M¹ is at least one element selected from the group consisting of Li, Na, K, Mg, Ca, Al, Zn, and transition metal elements, and −1≤a≤0.5, 0≤b≤0.5, 0≤c≤0.5, −0.2≤δ≤1); and a second negative electrode active material of at least one kind selected from the group consisting of M²ₓNb₁₋ₓO_{2.5-θ}, and M³_{y}M⁴_{1-y}O_{3-η} (each of M² and M³ is at least one element selected from the group consisting of Li, Na, K, Mg, Ca, Al, Zn, and transition metal elements, and M⁴ is at least one of W and Mo, and 0≤x≤0.8, 0≤y≤1.0, 0≤θ≤1.0, 0≤η≤1.0), wherein when a total amount of the first negative electrode active material and the second negative electrode active material contained in the negative electrode is assumed as 100 volume %, a proportion of the second negative electrode active material is 5 volume % or more, wherein when M²ₓNb₁₋ₓO_{2.5-θ} is contained as the second negative electrode active material, the proportion thereof is 95 volume % or less, wherein when M³_{y}M⁴_{1-y}O_{3-η} is contained as the second negative electrode active material, the proportion thereof is 25 vol % or less.

2. The lithium ion secondary battery according to claim 1, wherein the second negative electrode active material is M²ₓNb₁₋ₓO_{2.5-θ}, and the element M² is Ti, and, wherein h/S is a ratio of an area S (cm²) of an opposing area between the positive electrode and the negative electrode to a thickness h (cm) of the negative electrode, wherein Z (volume %) is a proportion of the second negative electrode active material when a total volume of the first negative electrode active material and the second negative electrode active material contained in the negative electrode is assumed as 100 volume %, wherein the following formula (1) is satisfied:
$$h / S < - 0.48 \times ( Z / 100 ) + 0.3 . \qquad ( 1 )$$

3. The lithium ion secondary battery according to claim 1, wherein the second negative electrode active material is M²ₓNb₁₋ₓO_{2.5-θ}, and the element M² contains at least Al, wherein h/S is a ratio of an area S (cm²) of an opposing area between the positive electrode and the negative electrode to a thickness h (cm) of the negative electrode, wherein Z (volume %) is a proportion of the second negative electrode active material when a total volume of the first negative electrode active material and the second negative electrode active material contained in the negative electrode is assumed as 100 volume %, wherein the following formula (2) is satisfied.
$$h / S < - 0.35 \times ( Z / 100 ) + 0.3 . \qquad ( 2 )$$

4. The lithium ion secondary battery according to claim 1, wherein the second negative electrode active material is M³_{y}M⁴_{1-y}O_{3-η}, wherein h/S is a ratio of an area S (cm²) of an opposing area between the positive electrode and the negative electrode to a thickness h (cm) of the negative electrode, wherein Z (volume %) is a proportion of the second negative electrode active material when a total volume of the first negative electrode active material and the second negative electrode active material contained in the negative electrode is assumed as 100 volume %, wherein the following formula (3) is satisfied:
$$h / S < - 0.34 \times ( Z / 100 ) + 0.3 . \qquad ( 3 )$$

5. The lithium ion secondary battery according to claim 1, wherein a ratio C of the solid electrolyte is 20 to 65% by volume when an apparent volume of the negative electrode is 100% by volume.

6. The lithium ion secondary battery according to claim 1, wherein the positive electrode contains at least one active material selected from the group consisting of LiCoO₂, LiNiO₂, LiMn₂O₄, LiNi_{0.5}Mn_{1.5}O₄, LiCoMnO₄, LiFePO₄, LiCoPO₄, and Li₂CoP₂O₇ as a positive electrode active material.

7. The lithium ion secondary battery according to claim 1, which is an all-solid-state secondary battery having a solid electrolyte layer interposed between the positive electrode and the negative electrode.
